(19) United States
(12) Patent Application Publication
(10) Pub. No.: US 2014/0334194 A1
(43) Pub. Date: Nov. 13, 2014

(54) Resonant Transition Controlled Flyback

(71) Applicants: Marco Davila, Tucson, AZ (US); Ian Poynton, Tucson, AZ (US)

(72) Inventors: Marco Davila, Tucson, AZ (US); Ian Poynton, Tucson, AZ (US)

(21) Appl. No.: 14/274,598

(22) Filed: May 9, 2014

Related U.S. Application Data
(60) Provisional application No. 61/821,884, filed on May 10, 2013.

(51) Int. Cl. H02M 3/335

(52) U.S. Cl. CPC H02M 3/33507
USPC 363/21.02

(57) ABSTRACT

A new and useful method and inductive circuit is provided that provides a resonant transition control that involves shorting the winding of an inductor or transformer to delay the natural ringing transition. The present invention provides for controlling the natural ring of an inductive circuit has a choke that stores and releases energy, a switch device having a closed state in which it causes the choke to store energy and another switch device having a closed state in which it causes the choke to release energy. The inductive circuit is configured with parasitic capacitance that would normally produce natural ringing when energy in the choke has been substantially released. The invention is characterized in that it provides for shorting the choke to trap and hold current and pause the natural ringing until power is directed to the inductive circuit to release shorting of the choke and initiate storage of energy in the choke.

### RELATED APPLICATION/CLAIM OF PRIORITY

This application is related to and claims priority from U.S. provisional application Ser. No. 61/821,884, filed May 10, 2013, which provisional application is incorporated by reference herein.

### INTRODUCTION

The present invention relates to an induction circuit in which resonant transition control involves shorting the winding of an inductor or transformer to delay the natural ringing transition. The principles of the present invention can be applied, e.g., to an induction circuit that is part of a flyback converter.

The Flyback converter is the most popular converter for off line applications. Applications include AC to DC adapters for laptops, tablets, cellular phones, and many other portable devices. Key to the Flyback topology's popularity is a simple design offering a wide operating range compared to other topologies. Also, in discontinuous mode the Flyback converter has discrete energy packets leading to higher efficiency at low output power. High efficiency at low output power is vitally important because the adapter is used for charging mobile devices and the majority of the users will leave an adapter plugged in requiring the adapter to be in standby or low power output mode. It has been statically proven that the standby power called vampire power causes more losses than the inefficiency of the unit while charging the mobile device.

In today's modern world of green efficiency and ever reduction in size of mobile devices the Flyback's ability to reduce standby power is not enough. Green initiatives require adapters to have higher efficiencies in all power modes. Another, possibly stronger, pressure for increased efficiency is reduction in size for cost and portability. When the adapter's size is reduced its ability to dissipate heat is also reduced. Not increasing the adapter's efficiency would lead to uncomfortable even dangerous operating temperatures. Decreasing the size of the adapter demands the efficiency of popular Flyback converter be increased in all power modes.

Several methods for increasing a Flyback's efficiency are in use today. Two methods in common use are synchronous rectification of the secondary and using the Flyback's ability to resonate to provide near zero or zero volt switching (ZVS). Synchronous rectification in the secondary decreases the loss associated with a diode rectifier. The resonant ZVS decreases the power needed to switch the MOSFETS at the cost of increased complexity of finding the valley point in the resonant waveform. Turning on the first ring is called boundary mode and turning on after the first ring is called discontinuous mode. To keep high efficiency at low power, the control method has to find the first resonant valley or any number of valleys after the reset cycle in order to reduce the frequency and still maintain some near zero volt switching. This is especially important at high input voltage (high line) where the switching burden is the highest. Higher input voltage increases the amount of energy dissipated in capacitive losses when switching MOSFETs. To alleviate the high line power losses associated with higher voltages synchronous rectification can be used to extend the reset cycle so that reverse current accumulates in the transformer. This increases the size of the resonant transition reducing the voltage at which the MOSFET turns on at. Because this increase in resonant ring energy does use power, control becomes more complicated in trading off the added energy versus power loss by switching at a higher voltage. Another problem that arises from adding extra energy into the resonant ring down is the increase of the energy in the resonant ring up which can cause the synchronous rectifier in the secondary to falsely turn on causing the convertor to actually pull power from the load instead of delivering power.

Various patents have emerged that use complicated methods to control the ring, control the synchronous rectifier in the secondary to ignore the ring up, timing the transition between boundary to burst to discontinuous mode, etc. What is needed is a simple method to control resonant switching on the Flyback topology, prevent ring back, be compatible with low power, and not have complex mode changes, and be compatible with synchronous rectification.

### SUMMARY OF THE PRESENT INVENTION

The present invention simplifies the control while improving the efficiency of the Flyback converter in all situations. The invention provides a very simple and novel approach to solving all the problems presented with Flyback converter topology. Moreover, the principles of the invention are applicable, e.g., to an induction circuit that can not only be part of a flyback circuit, and also to an induction circuit that can be part of other converters and transformers, e.g. boost circuits, SEPIC circuits, and two transistor forward circuits.

More specifically, the present invention provides a resonant transition control method and circuit that involves shorting the winding of an inductor or transformer to delay the natural ringing transition. The present invention provides for controlling the natural ring of an inductive circuit has a choke that stores and releases energy, a switch device having a closed state in which it causes the choke to store energy and another switch device having a closed state in which it causes the choke to release energy. The inductive circuit is configured with parasitic capacitance that would normally produce natural ringing when energy in the choke has been substantially released. The invention is characterized in that it provides for shorting the choke to trap and hold current and pause the natural ringing until power is directed to the inductive circuit to release shorting of the choke prior to initiating storage of energy in the choke.

With an inductive circuit according to the present invention, after the energy in the choke is substantial released and before the pause, the switch device that releases the energy remains closed for an extra period of time so that energy is increased in the choke in the opposite direction of the original energized state, thus adding with the energy in the parasitic capacitance and increasing the natural ring energy or amplitude.

The invention can provide for controlling the load versus frequency and pulse size of the inductive circuit, to produce optimal frequency and pulse size for the inductive circuit.

In addition the release switch device releases energy that is directed to remain in the on state for a longer period of time, and the amount of energy stored in the reverse direction is increased and tailored for a specific load and input voltage.

In one implementation the invention is designed so that the inductive circuit is provided as part of a flyback circuit.

In another implementation the inductive circuit is provided as part of a boost circuit.

In yet another implementation the inductive circuit is provided as part of a SEPIC circuit.

In still another implementation the inductive circuit is provided as part of a two transistor forward circuit.

These and other features of the present invention will become further apparent from the following detailed description and the accompanying drawings

### BRIEF DESCRIPTION OF THE DRAWINGS

FIG. 1 illustrates a simple flyback circuit;

FIG. 2 illustrates a typical flyback voltage and current waveforms on a primary switch;

FIG. 3 shows the waveforms for the flyback converter at high line;

FIG. 4 is the waveform of the inductive circuit of the flyback converter;

FIG. 5 shows what happens if the switch does not turn on at the first ring;

FIG. 6 shows what would happen if the ring down of the inductive circuit during the resonant ring down, according to the present invention;

FIG. 7 shows a typical frequency versus load of a flyback converter with a complex control method;

FIG. 8 shows a typical boundary mode flyback converter operating a full load at high input and low input;

FIG. 9 shows the flyback converter of FIG. 8, using the shorted winding technique of the present invention;

FIG. 10 shows implementation of the principles of the present invention for optimizing tradeoff between circulating current and switch losses;

FIGS. 11 and 12 show implementation of the principles of the present invention to a boost converter circuit and FIG. 17 shows implementation to a SEPIC circuit;

FIGS. 13 and 14 show implementation of the principles of the present invention to a two transistors forward circuit; and

FIGS. 15 and 16 show how the inductive circuit, according to the present invention, can be controlled by a microcomputer.

### DETAILED DESCRIPTION

As described above, the principles of the present invention are particularly applicable to an inductor circuit that can be part of a converter or transformer such as flyback circuits, boost circuits, SEPIC circuits, and two transistor forward circuits. The invention is described herein in connection with such circuits, and from the description, the manner in which the present invention can be applied to various comparable types of converters and transformers will be apparent to those in the art.

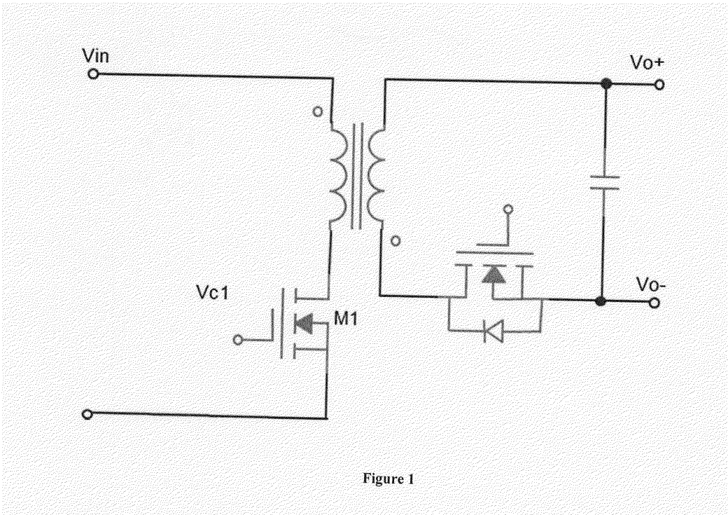

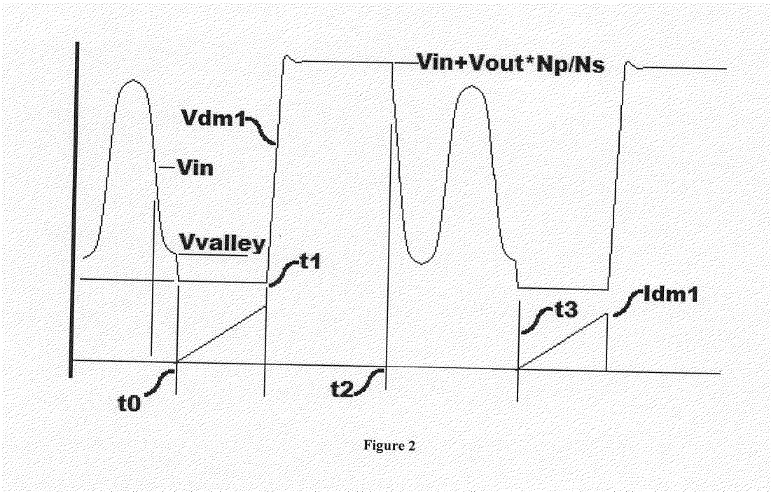

Presented in FIG. 1 is a simple Flyback circuit comprising an inductive circuit with a primary switch and secondary switch. And presented in FIG. 2 is a typical Flyback voltage and current waveforms on the primary switch. Notice that after the reset cycle at time t2 the winding starts to ring. This ringing is caused by the parasitic capacitances of the primary switch, the synchronous rectifier or diode in the secondary, and the interwinding capacitance of the transformer windings. Note that there are discrete times in which it is more efficient to re-turn on the primary switch. This would occur at any valley location where the voltage at turn on would be the lowest. In FIG. 2 the primary switch turned on at the ideal time, it turned on at the valley point on the second ring down. The controller has adjusted the frequency so that the switch would turn on at the valley.

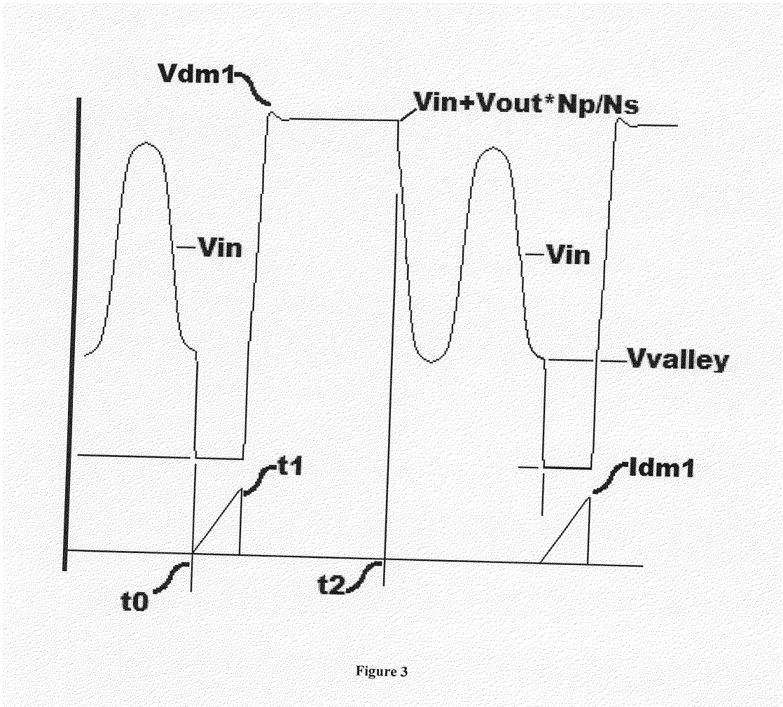

FIG. 3 shows the waveforms for the flyback converter at high line. Since the unit is at high line the valley voltages are not close to zero. The maximum ringing amplitude, with no extra energy added, is equal to the reflected output voltage during reset. For example, if the input voltage is 100 and the transformer has a turns ratio of 1:1 and is producing an output voltage of 40 the lowest the turn on point would be 100-40 which is equal to 60. Turn on loss, assuming linear capacitance in the circuit, is proportional to the square of the voltage at turn on and that would be 60 squared. If the switch would turn on at the top of the ring the dissipation would be proportional to 140*140, a huge difference between the two (more than 5 times larger in this example). This amount of dissipation difference cannot be ignored.

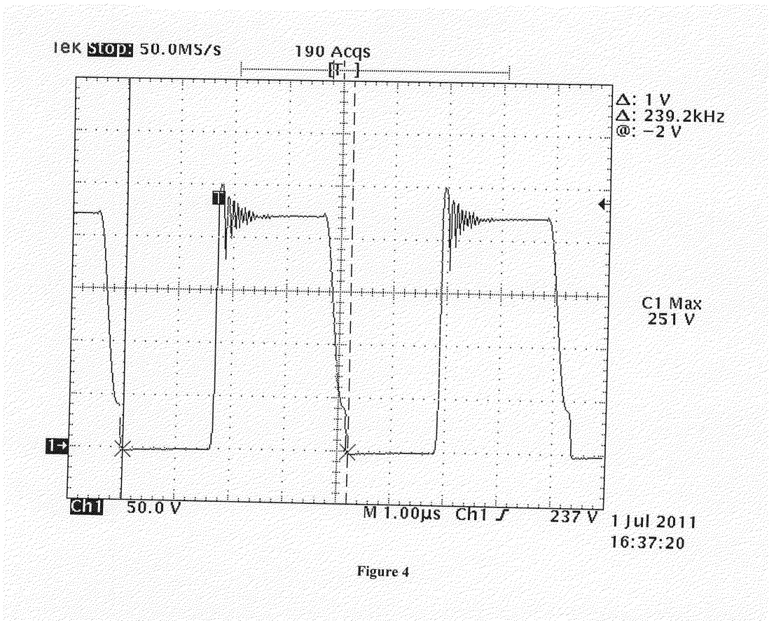

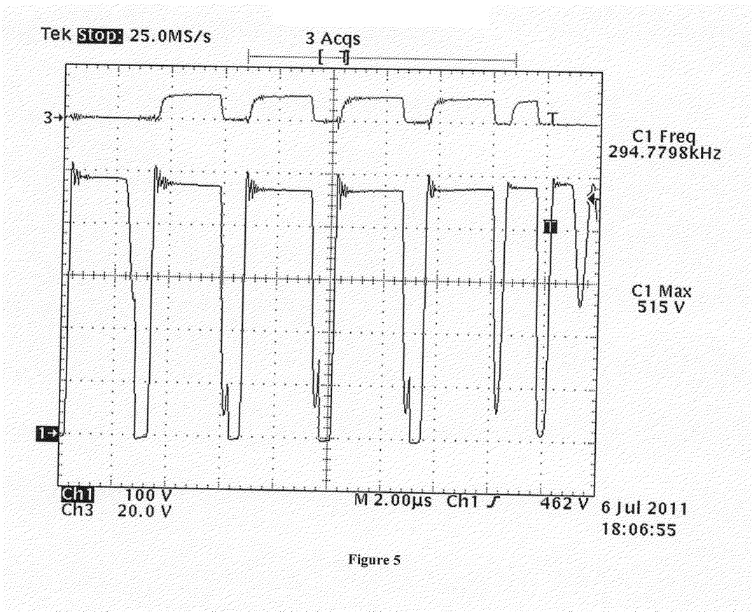

FIG. 4 is the waveform of the inductor circuit of the flyback converter if the synchronous rectifier is held on a little longer than is needed to increase the energy of the ringing (referred in this document as push back energy). This energy is taken from the output and there is a penalty that this energy has to be restored once used. The peak current in the primary is increased to compensate for the extra energy needed by the output. This increases the overall circulating current but improves the efficiency of each turn on provided that the primary switch takes advantage of it. FIG. 4 has the primary switch turning on at the first ring (boundary mode) which is another improvement of the energy dissipated at turn on. There is a tradeoff between the extra conduction losses caused by the increase in circulating current and benefiting from the reduction in switching losses at turn on but in all cases some improvement can be realized by increasing some amount of this energy.

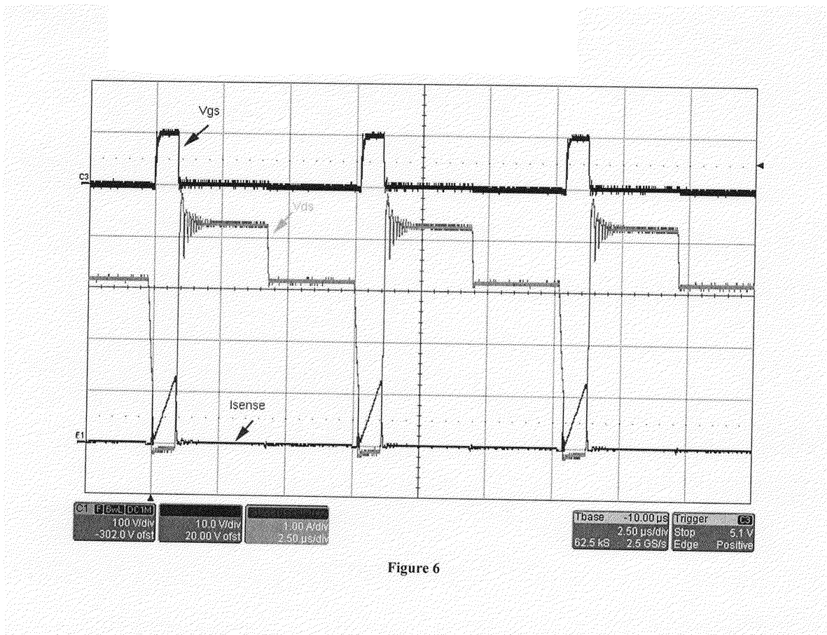

FIG. 5 shows what happens if the switch does not turn on at the first ring. If the switch does not turn on the first ring, the push back energy stored by the synchronous rectifier causes the ring to come back up past the rectification point. If the synchronous rectifier circuit is triggered by drop across it, the circuitry would turn on the switch again and produce again a large ring. This in turn puts energy back again into the ring in a process that does not end. This would produce larger amounts of circulating current that would kill the efficiency of the unit. What is shown in Figure is a “semi smart control” that did not add energy on the second try but it got “fooled” the first time. This control would be more complex and even with this control there would be more power dissipated since the unit invested energy in trying to produce a large ring but did not utilize it due to the lower output load requirements.

As presented many complicated solutions have been tried and patented to solve this problem. A simpler solution is needed. So the question was asked. “How to stop the resonant ring from going up?” A simple solution has been discovered, in accordance with the present invention. This solution is to short the winding of the transformer leaving the energy stored in the transformer. Continuing even further short the winding during the resonant ring down. Basically this captures the energy for use any time the primary switch needs to be turned on as well as preventing the ring up.

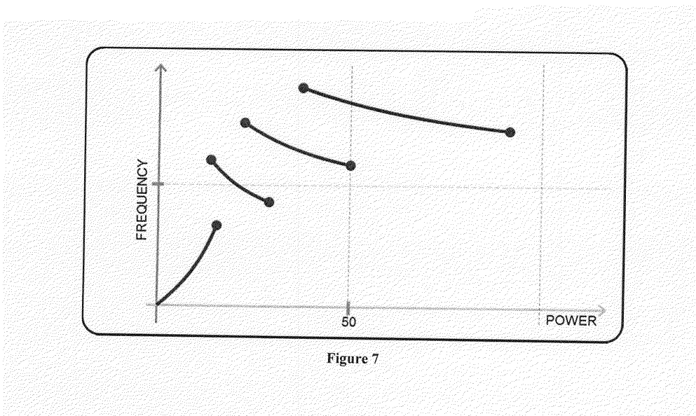

FIG. 6 shows what would happen if we could control the ring down by shorting the winding. This solves the synchronous rectification problem because the only time the converter would ring would be to turn on. In other words, the converter can turn on the first ring exactly like FIG. 4 only that the ring down is delayed by keeping the winding shorted until the control needs to turn on.

This not only solves the synchronous rectifier false turn on problem, it also solves all other problems previously described. The ability to now store the energy for primary switch turn on creates opportunities for improvements at all points in the operating range.

Shown in FIG. 7 is a typical frequency versus load of a Flyback with a complex control method. Notice that the frequency has abrupt discontinuities. This is due to the changes in this particular control IC of changing to a different valley (a change in the number of rings before a turn on happens). During these abrupt changes the feedback loop is subjected to something similar to a transient load change. It is even possible for the unit oscillate between two different valley positions producing unpredictable ripple on the output. Because of this some IC provide hysteresis between these modes complicating the design of the control chip.

By controlling the resonant transition timing fully, according to the principles of the present invention, there is no difference between boundary mode and discontinuous mode if the winding is kept shorted. They merge into the same mode. The unit will always be in discontinuous mode but with the benefits of boundary mode of having a large first resonant transition. The control loop would not go through any jumps or discontinuities when a new valley position is changed. Complex control schemes that counted the number of rings are eliminated. Burst control methods in which a few boundary mode cycles are produced followed by dead times is not needed. Valley detection algorithms are not needed (the resonant transition happens at a fixed delay from the release of the short). The frequency would go down from high load to no load smoothly unlike boundary mode schemes in which the frequency would actually increase from full load to lighter load and would have an abrupt frequency change when the unit changed to discontinuous mode or burst mode. The control would be simplified on both the synchronous rectification and also for primary switch control that required in the past all these mode changes, protection, and valley detection.

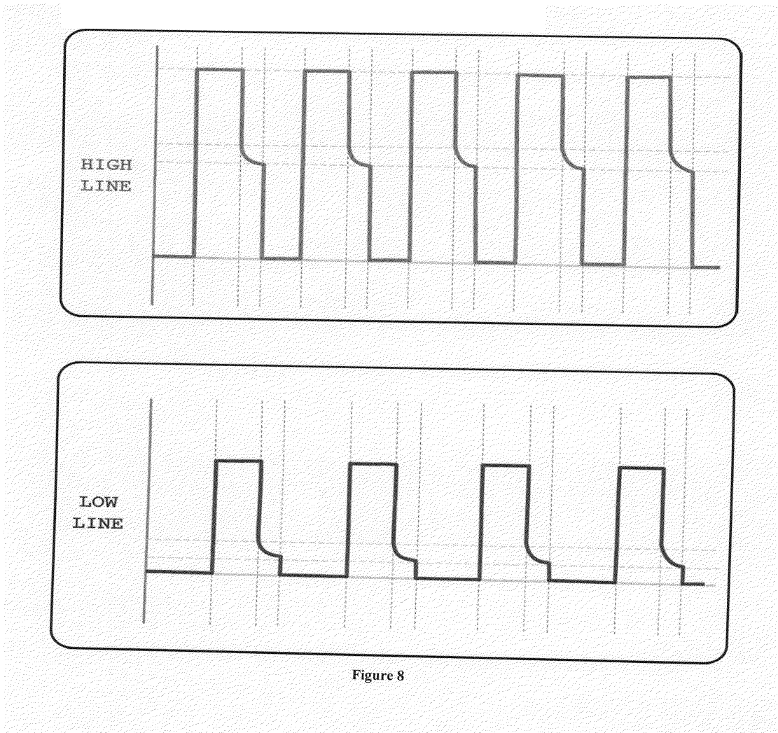

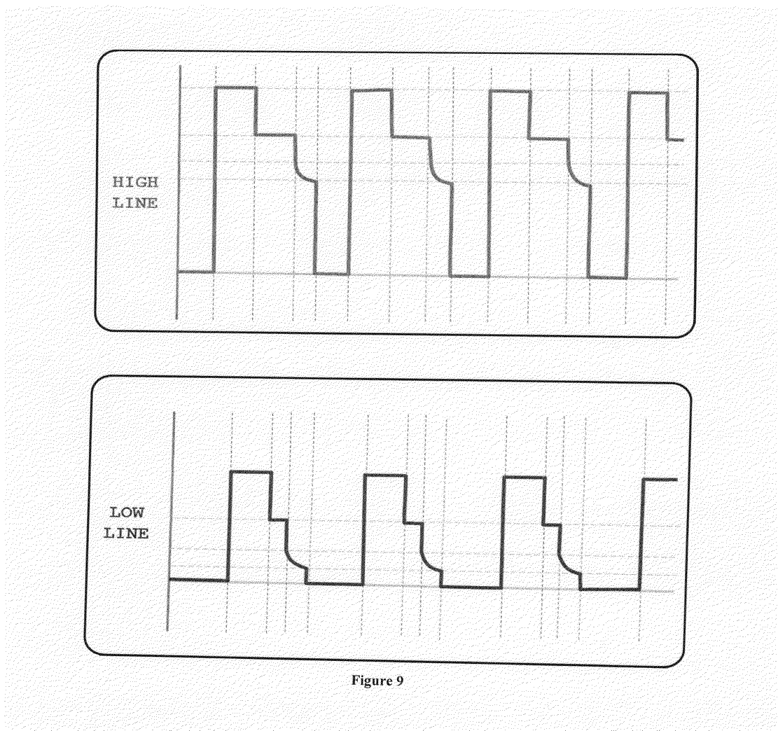

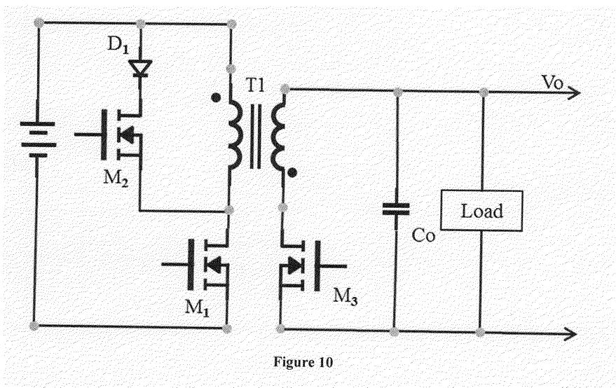

FIG. 8 shows a typical boundary mode Flyback operating at full load at high input and low input. Notice that the frequency at high line is much higher than for the same power than low line. At high line a lower frequency would be desirable since the losses at turn on are higher; reducing the frequency would mitigate the higher losses. Unfortunately, the opposite happens which further aggravates the losses. FIG. 9 shows the same Flyback using the shorted winding technique. Notice that the frequency is the same or lower for high line. In fact the frequency of operation can be chosen. Resonant control of the winding allows for another degree of freedom. Since the amount of time the winding is shorted can be changed, the switching frequency can be chosen at any load or input voltage. This allows the unit to optimize the efficiency at every load and input situation. High line efficiency was improved by decreasing the frequency and not wasting the push back energy in extra ringing cycles. The push back energy is fully utilized when the primary switch turns on.

Because of the extra degree of freedom, the control would be able to tailor the optimum operating conditions for a particular Flyback converter. A table of values that stores the frequency and peak current settings for a particular input line and load can be stored on a micro-controller or a power versus frequency line can be designed in an analog controller.

The table can also contain the amount of push back energy required at these conditions that would change the turn off time of the synchronous rectifier. This would change the amount of energy invested in for every load condition. This would optimize the tradeoff mentioned before between circulating current and switching losses.

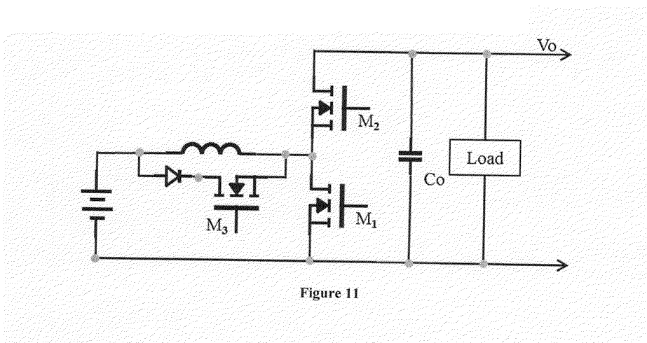

The penalty of this idea is that an extra switch is needed to control the short on the winding. Compared with the increase complexity of the control without the switch, this method has been found to be more economical. The improvement in efficiency at high input voltage and light loads reduces the overall size and cost of the converter. Shown in FIG. 10 is one embodiment of the new idea. By using the diode D1 in series with MOSFET M2, a shorting direction can be defined without interfering with the natural reset in the secondary. The shorting MOSFET M2 is turn on during the reset time so that it turns on at zero voltage. The topology is also compatible with a diode rectified secondary and can give an efficiency improvement path for existing Flyback converter designs.

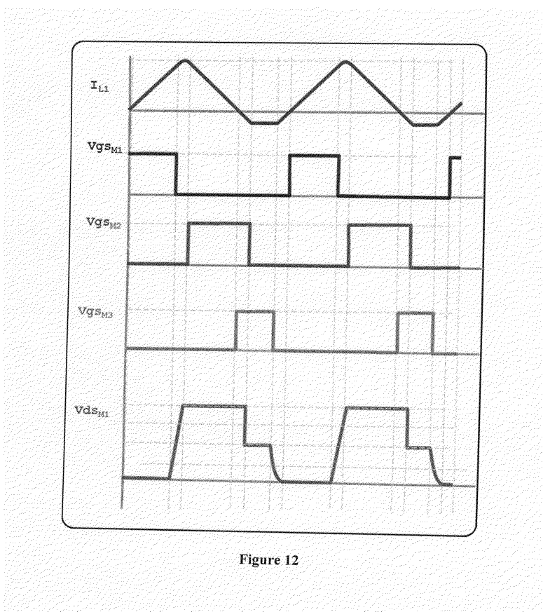

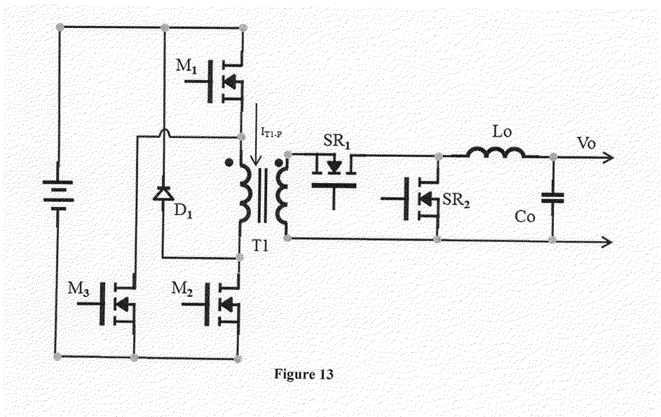

While this idea was implemented on a Flyback converter it can be applied to other topologies. One transistor forward converter, two transistor forward converter, boost converter, interleaved 2 transistor converter, buck converter, resonant converter, and SEPIC converters and others can apply this idea. Any converter that has a ringing transition can be interrupted in the middle of the transition to provide dead time and reduce the operating frequency. This idea is more suited to converters that are designed to run in discontinuous and boundary mode conditions. To illustrate this point, a boost converter with synchronous rectifier and a winding shorting switch is shown in FIG. 11 along with typical waveforms shown in FIG. 12.

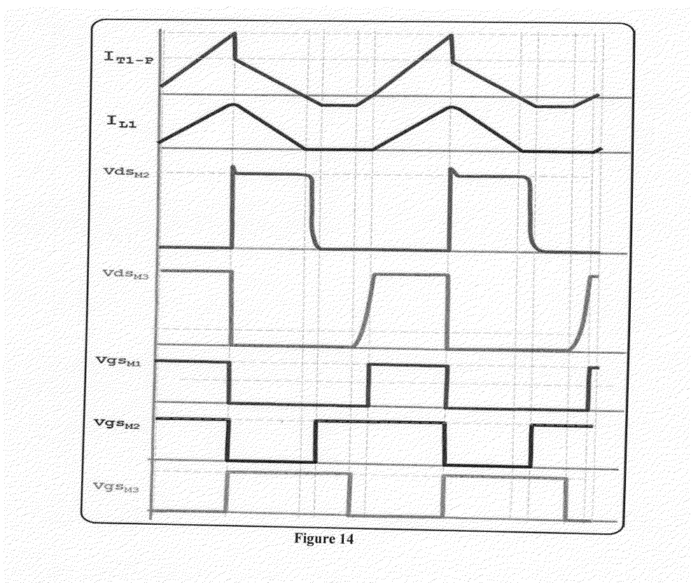

A two transistor forward implementation is shown in FIG. 13 with waveforms in FIG. 14. The current in the output choke must reach zero before the reset is done in the primary otherwise the output choke could “steal” some of the energy in the ringing transitions. Interleaving with another 2 transistor forward will alleviate this limitation and the output choke current can be continuous without impacting the ZVS transitions in the primary.

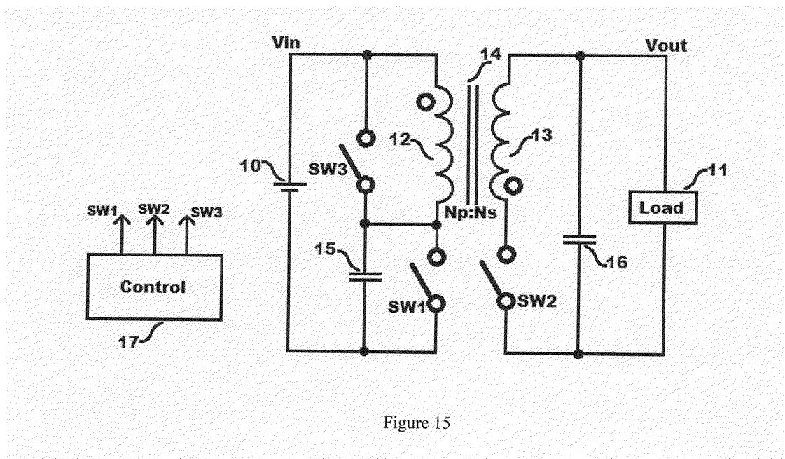

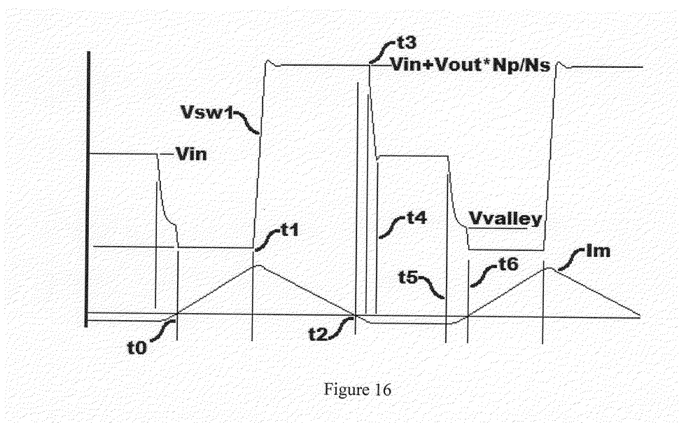

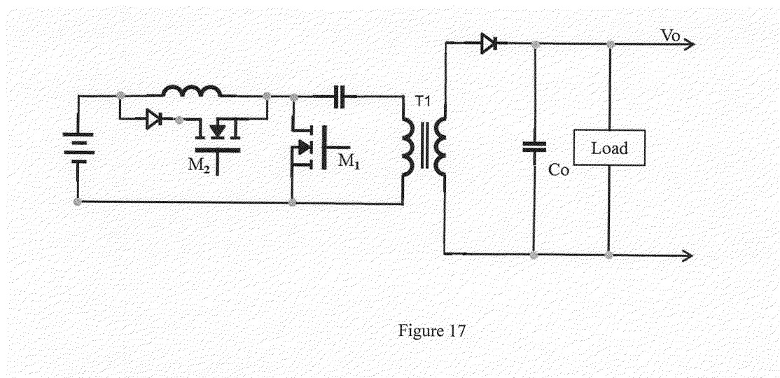

As illustrated by FIGS. 15 and 16, the circuit can be controlled by a micro-computer 17 so that the optimal frequency and pulse size are tailored by a table in the micro-controller or a circuit that changes the load vs. frequency and pulse size (e.g. the micro computer 17 controls primary and secondary switches SW 1, SW 2, and shorting switch SW 3 to tailor the frequency and pulse size), and the micro computer can also be used to tailor the amount of energy stored in the reverse winding for a specific load and input voltage).

FIG. 16 describes the voltage waveform on SW1 and the magnetizing current in transformer 14. At t0 the SW1 is turned on and is left on until t1. The magnetizing current in the transformer increases as in a normal Flyback converter. At t1 when SW1 turns off the current in winding 12 charges capacitor 15, When the voltage on winding 13 reaches the output voltage SW2 is turned. The magnetizing current then flows in winding 13 producing output current into load 11 and capacitor 16. The magnetizing current decreases as it delivers energy to the output. At t2, the magnetizing current crosses zero and then reverses from the output back into transformer 14. At a specified current or in other words energy controlled by control circuit 17, SW2 turns off. The reverse current magnitude represents energy stored in the transformer that will be used to near zero or zero volt switch SW1 later in the cycle. At time t4, SW3 is turned on effectively shorting winding 12 and preventing the energy stored to be used. The current stored at t2 and any extra energy from voltage on SW1 moving from Vin plus reflective output voltage to Vin is conserved by SW3 and circulates in winding 12 until time t5 when SW3 is turned off. At this time, energy stored is used to discharge capacitor 15 to a determined turn on voltage (Vvalley). At this lowest voltage point t6, SW1 is turned on which is a start of a new cycle (same as t0). The time between t4 and t5 can be tailored to control the frequency, this in combination with the time SW1 is on determine the frequency and power per cycle for the unit at a certain load condition. By having the flexibility of controlling the time between t4 and t5, the frequency can be tailored for maximum efficiency at any load condition.

Finally, as described above, the present invention can also be implemented in SEPIC converters. Single-ended primary-inductor converter (SEPIC) is a type of DC-DC converter allowing the electrical potential (voltage) at its output to be greater than, less than, or equal to that at its input; the output of the SEPIC is controlled by the duty cycle of the control transistor. FIG. 17 shows a SEPIC circuit topology that implements the principles of the present invention.

Thus, as seen from the foregoing description, applicants have provided a new and useful concept for simplifying control of an inductive circuit (e.g. in a flyback converter) while improving the efficiency of the flyback converter in all situations. The invention provides a very simple and novel approach to solving all the problems presented with flyback converter topology. Moreover, the principles of the invention are applicable, e.g., to an induction circuit that can not only be part of a flyback circuit, and also to an induction circuit that can be part of other converters and transformers, e.g. boost circuits, SEPIC circuits, and two transistor forward circuits. The present invention provides a resonant transition control method and circuit that involves shorting the winding of an inductor or transformer to delay the natural ringing transition. The present invention provides for controlling the natural ring of an inductive circuit has a choke that stores and releases energy, a switch device having a closed state in which it causes the choke to store energy and another switch device having a closed state in which it causes the choke to release energy. The inductive circuit is configured with parasitic capacitance that would normally produce natural ringing when energy in the choke has been substantially released. The invention is characterized in that it provides for shorting the choke to trap and hold current and pause the natural ringing until power is directed to the inductive circuit to release shorting of the choke and initiate storage of energy in the choke. With an inductive circuit according to the present invention, after the energy in the choke is substantial released and before the pause, the switch device that releases the energy remains closed for an extra period of time so that energy is increased in the choke in the opposite direction of the original energized state, thus adding with the energy in the parasitic capacitance and increasing the natural ring energy or amplitude. The invention can provide for controlling the load versus frequency and pulse size of the inductive circuit, to produce optimal frequency and pulse size for the inductive circuit. In addition the release switch device releases energy that is directed to remain in the on state for a longer period of time, and the amount of energy stored in the reverse direction is increased and tailored for a specific load and input voltage. From the foregoing description, the manner in which the present invention can be applied to various comparable types of converters and transformers will be apparent to those in the art.

1. A resonant transition control method that involves shorting the winding of an inductor or transformer to delay the natural ringing transition.

2. A method of controlling the natural ring of an inductive circuit, comprising
a. providing an inductive circuit with a choke that stores and releases energy, a switch device having a closed state in which it causes the choke to store energy and another switch device having a closed state in which it causes the choke to release energy, the inductive circuit configured with parasitic capacitance that would normally produce natural ringing when energy in the choke has been substantially released and
b. shorting the choke to trap and hold current and pause the natural ringing until power is directed to the inductive circuit to release shorting of the choke prior to initiating storage of energy in the choke.

3. The method of claim 2, wherein the inductive circuit is configured such that after the energy in the choke is substantial released and before the pause, the switch that releases the energy remains closed for an extra period of time so that energy is increased in the choke in the opposite direction of the original energized state thus adding with the energy in the parasitic capacitance increases the natural ring energy or amplitude.

4. The method of claim 3, further comprising controlling the load versus frequency and pulse size of the inductive circuit, to produce optimal frequency and pulse size for the inductive circuit.

5. The method of claim 4, wherein the release switch device that releases energy is controlled to remain in the on state for a longer period of time, enabling the amount of energy stored in the reverse direction to be increased and tailored for a specific load and input voltage.

6. The method of claim 2, wherein the inductive circuit is provided as part of a flyback circuit.

7. The method of claim 2, wherein the inductive circuit is provided as part of a boost circuit.

8. The method of claim 2, wherein the inductive circuit is provided as part of a SEPIC circuit.

9. The method of claim 2, wherein the inductive circuit is provided as part of a two transistor forward circuit.
